(19) United States
(12) Patent Application Publication
(10) Pub. No.: US 2004/0262828 A1
(43) Pub. Date: Dec. 30, 2004

(54) Device to provide initial pop-up of an automotive deck lid via a gas spring

(76) Inventor: Walter Douglas Bauman, Wixom, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/602,286

(22) Filed: Jun. 24, 2003

(51) Int. Cl. F16F 9/00

(52) U.S. Cl. 267/120

(57) ABSTRACT

A support assembly for a vehicle closure member includes a gas spring that biases an arm against the vehicle closure member and toward an initial opening pop-up position. The support assembly includes the arm pivotally attached to the vehicle body. The arm includes a first segment pivotally attached to a gas spring and a second segment contacting the vehicle closure member. The gas spring is attached to the closure member on a segment distal from the segment pivotally attached to the arm. A biasing force exerted by the gas spring causes rotation of the arm about the pivot point such that the second segment of the arm contacts and forces the vehicle closure member to the desired initial pop-up opening position.

### BACKGROUND OF THE INVENTION

This invention generally relates to a support assembly for a vehicle closure member, and specifically to a support assembly that moves a vehicle closure member from a closed position to an initial opening pop-up position.

Conventional vehicle closure members such as tailgates and hatchbacks are supported by one or more gas springs mounted between the vehicle and the vehicle closure member. The gas springs are often mounted within water runoff channels disposed on each side of the closure member. The gas springs provide a counter balance force to reduce the amount of effort required to open the vehicle closure member. Further, the gas springs operate to hold the vehicle closure member in an open position.

The mounting location of the gas springs is typically within the water runoff channels to conceal hinges and the support assembly. Mounting of the gas springs within the water runoff channels may cause initial movement of the vehicle closure member to be more difficult than movement once the closure member is in motion. Difficult initial movement is due to the line of biasing forces exerted by the gas springs originating relatively close to the closure member hinge axis. The close proximity to the hinge axis reduces the amount of counter balance force available to assist in initial opening of the vehicle closure member. Movement from an initially closed position therefore requires additional manual effort.

Levers, cams and other conventional force increasing systems are often provided to move the closure member to an initial pop-up opening position upon unlatching of the vehicle closure member. Typically, such systems are complicated, bulky and require modification to the existing configuration of the closure member and vehicle body.

Accordingly, it is desirable to develop a closure member support assembly that provides an initial pop-up opening position, which substantially decreases the initial effort required to move the closure member from the closed position.

### SUMMARY OF INVENTION

The present invention is a support assembly for a vehicle closure member assembly that includes a gas spring biasing an arm against the closure member toward an initial pop-up opening position.

The arm includes a first segment pivotally attached to a gas spring and a second segment contacting the closure member. The gas spring is attached to the closure member opposite the segment pivotally attached to the arm. A biasing force exerted by the gas spring causes rotation of the arm about a pivot point such that the second segment of the arm contacts and forces the closure member to the desired pop-up initial opening position.

Accordingly, the present invention provides a support assembly for providing an initial pop-up opening position that substantially decreases initial effort required to move the closure member from the closed position.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a side view of a vehicle closure member and the inventive support assembly with the closure member in the closed position;

FIG. 2 is a side view of the vehicle closure member in an initial opening pop-up position;

FIG. 3 is a side view of the vehicle closure member moved past the initial opening pop-up position toward a fully open position; and

FIG. 4 is an enlarged view of the gas spring and arm of the support and opening assembly.

### DETAILED DESCRIPTION OF THE PREFERRED EMBODIMENT

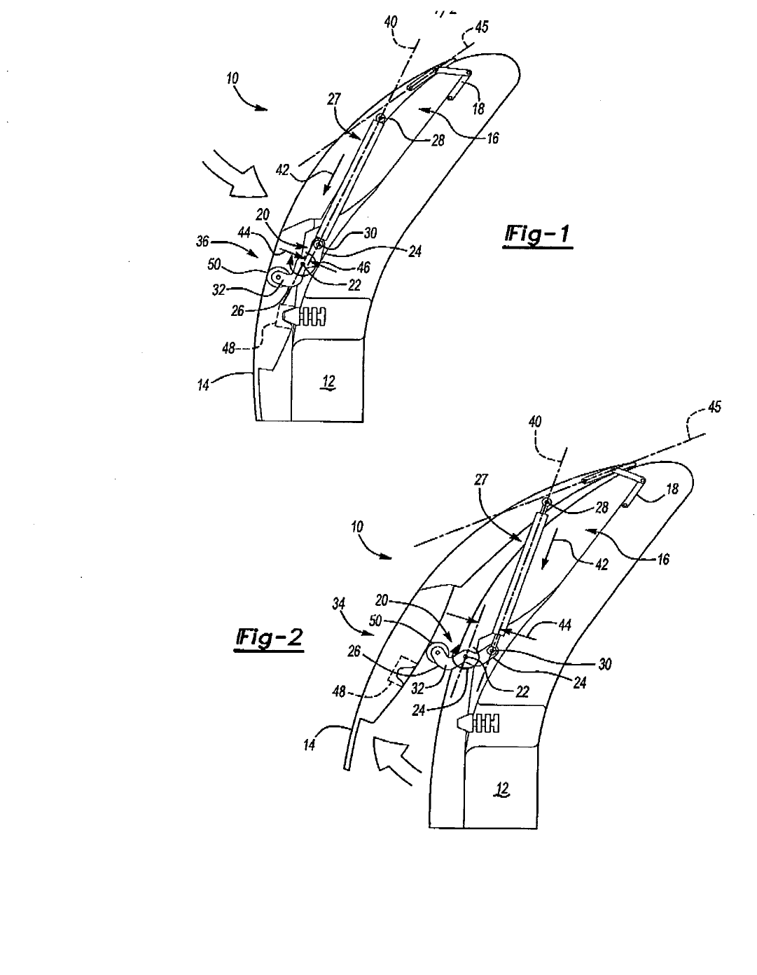

Referring to FIGS. 1 and 4, a vehicle closure assembly 10 includes a closure member 14 that is movable between open and closed positions and supported for this movement by a hinge assembly 18. The hinge assembly 18 is preferably a four bar linkage as is known in the art. A gas spring 27 includes first and second segments 28, 30. The first segment 28 is pivotally attached to the closure member 14 and the second segment 30 is pivotally attached to an arm 20. The arm 20 is pivotally attached to the vehicle body 12 and includes first and second segments 24, 26. The gas spring 27 biases the arm 20 about a pivot point 22 such that the second segment 26 lifts the closure member 14 to an initial opening pop-up position 34 (FIG. 2).

The gas spring 27, hinge assembly 18 and arm 20 are preferably mounted to the vehicle 12 within a water runoff channel 16. The arm 20 and gas spring 27 of the present invention are shown mounted within the water runoff channel 16, however, it is with in the contemplation of this invention to mount the gas spring 27 and arm 20 between the closure member 14 and vehicle 12 in any position as is required by the specific application.

The initial opening pop-up position 34 (FIG. 2) provides a visual reference to a vehicle operator that the closure member 14 is open. In addition, the pop-up position 34 moves the closure member 14 to an initial position such that the initial effort of moving the closure member 14 is reduced. An axis 40 along which the gas spring 27 provides biasing force is close to a hinge axis 45 and therefore provides less counterbalance force and less of an assist at smaller opening positions than at other opening positions where the axis 40 is moved further away from the hinge axis 45. Therefore, the initial opening pop-up position 34 moves the vehicle closure member 14 to a position where counterbalance force of the gas spring 27 is increased to aid in further opening of the vehicle closure member 14.

The gas spring 27 biases the arm 20 about the pivot point 22 such that the second segment 26 of the arm 20 contacts and pushes upward against the closure member 14. An upward biasing force (shown by arrow 42) exerted by the gas spring 27 acts along an axis 40 defined between the first and second segments 28,30 of the gas spring 27. The force 42 causes the arm 20 to rotate about the pivot point 22 and upward into the closure member 14. A latch 48 holds the closure member 14 in the closed position against the biasing force exerted by the gas spring 27 through the arm 20 when in the closed position indicated at 36 in FIG. 1.

The pivot point 22 is disposed a distance 44 from the axis 40 causing the biased rotation 46 of the arm 20 into the closure member 14. The distance 44 between the axis 40 and pivot 22 provides a desired amount of biasing force against the closure member 14. In response to release of the latch 48; the closure member 14 moves to the initial opening pop-up position (34, best shown in FIG. 2). As distance 44 from the axis 40 to the pivot 22 is increased, the magnitude of force transmitted to rotation of the arm 20 is increased. Therefore, location of the pivot 22 relative to the hinge axis 44 is dependent on application specific parameters, such as member weight and size.

Referring to FIG. 2, release of a latch 48 allows the closure member 14 to move upward toward the fully open position. The biasing force 42 causes rotation of the arm 20 thereby moving the second segment 26 and the closure member 14 upward from the closed position to the initial opening pop-up position 34.

The second segment 26 of the arm 20 includes an extension 32 (FIG. 4) to further leverage the closure member 14 upward from the closed position (36 FIG. 1). The extension 32 is angled relative to the arm 20 and into contact with the closure member 14. The extension 32 leverages the biasing force exerted by the gas spring 27 to lift the closure member 14. The extension segment 32 of the arm 20 additionally includes rollers 50 to reduce the affects of friction on the interface between the arm 20 and the closure member 14. Although a roller 50 is illustrated, it is within the contemplation of this invention to provide other friction reducing devices, such as low friction contact surfaces that reduce friction and protect the finish coating of the closure member 14.

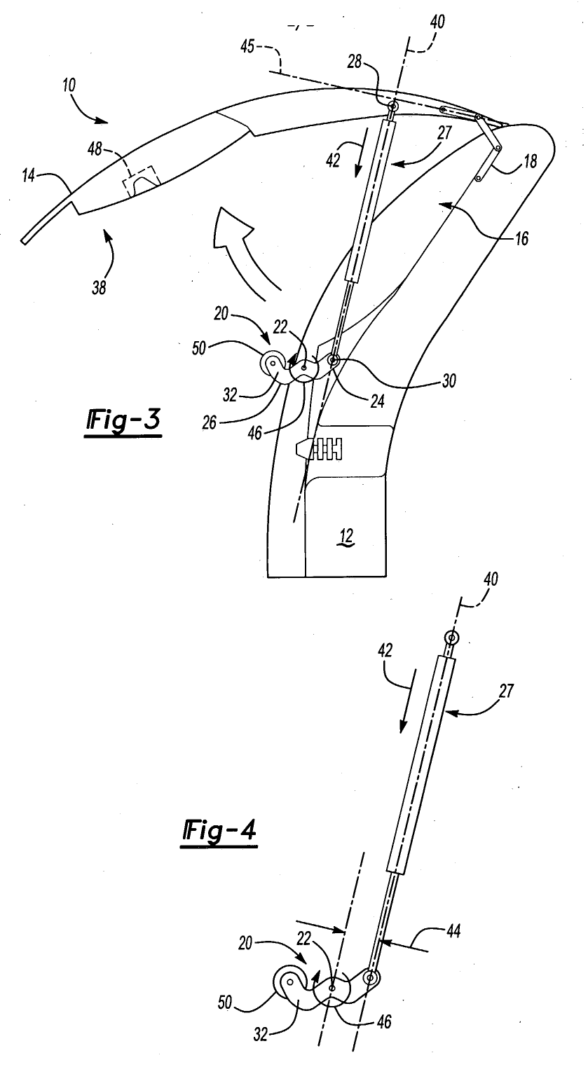

Referring to FIG. 3, once the latch 48 is released, the closure member 14 will move to the initial opening pop-up position 34. A vehicle operator is then free to move the closure member 14 upward toward the fully open position 38. The gas spring 27 assists in lifting and supporting the closure member 14 in intermediate open positions as is known.

The arm 20 rotates such that the first segment 24 contacts a surface of the of the water runoff channel 16 to stop rotation. The gas spring 27 maintains the position of the first segment of the arm 20 against the water runoff channel 16 because of the biasing force 42 exerted along the axis 40.

Although a gas spring 27 is used in the illustrated embodiment, it is within the contemplation of this invention to use other springs known in the art for biasing the arm 20 and supporting the closure member 14, such as for example, pneumatic springs.

In operation, the gas spring 27 creates a biasing force against the closure member 14 toward an open position. The latch 48 holds the closure member 14 in the closed position. The second segment 26 of the arm 20 is biased to push the closure member 14 toward the open position. Release of the latch 48 frees the arm 20 to rotate and move the closure member 14 to the initial opening pop-up position. From the initial pop-up position, the closure member 14 can be lifted to further open positions.

The support and opening assembly of this invention is mountable without extensive modification to existing closure members and vehicle body configuration. The simple mounting configuration eliminates costly and complex mechanisms reducing weight and providing a smaller overall assembly, easily adaptable into various closure member applications.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

1. A support assembly for a vehicle closure member comprising:
an arm pivotally mounted about and arm pivot and comprising a first segment and a second segment and
a spring assembly pivotally attached to said first segment at a spring pivot and biasing said second segment against the vehicle closure member.

2. The assembly as recited in claim 1, further comprising a hinge assembly to move the vehicle closure member between an open position and a closed position.

3. The assembly as recited in claim 2, wherein said second segment biases the vehicle closure member toward said open position.

4. The assembly as recited in claim 1, including an extension portion extending transversely from said second segment and into contact with the vehicle closure member.

5. The assembly as recited in claim 1, wherein said second segment is longer than said first segment.

6. The assembly as recited in claim 1, wherein said spring assembly comprises a support segment and a base segment disposed along a common axis and said arm pivot is spaced apart from said common axis.

7. The assembly as recited in claim 6, wherein said pivot is spaced apart from said common axis a distance such that said first segment is biased away from the vehicle closure member and said second segment is biased upward against the vehicle closure member.

8. The assembly as recited in claim 1, comprising a roller attached to said second segment for contacting the vehicle closure member.

9. The assembly as recited in claim 1, wherein said spring assembly comprises a gas spring.

10. The assembly as recited in claim 1, wherein said spring assembly comprises a pneumatic spring.

11. A gas spring assembly for a vehicle closure member comprising:
a gas spring comprising a support segment and a base segment, said support segment pivotally attachable to the vehicle closure member; and
an arm comprising a first segment and a second segment and a pivot disposed therebetween, said first segment pivotally attached to said base segment and said second segment positioned to be biased by said gas spring against the vehicle closure member.

12. The assembly as recited in claim 11, wherein said second segment is positioned to bias the vehicle closure member toward an open position.

13. The assembly as recited in claim 11, including an extension portion extending transversely from said second segment to contact the vehicle closure member when the assembly is attached to the vehicle closure member.

14. The assembly as recited in claim 11, wherein said second segment is longer than said first segment.

15. The assembly as recited in claim 11, wherein said support segment and base segment arc disposed along a common axis and said pivot pin is spaced apart from said common axis.

16. The assembly as recited in claim 15, wherein said pivot is spaced apart from said common axis a distance such that said first segment will be biased downward and said second segment will be biased upward against the vehicle closure member when the assembly is attached on a vehicle closure member.

17. The assembly as recited in claim 11, comprising a roller attached to said second segment for contacting the vehicle closure member when the assembly is attached to a vehicle closure member.

18. The assembly as recited in claim 11, wherein said first segment and said second segment extend in opposing directions from said pivot.

19. The assembly as recited in claim 1, wherein said first segment extends from said pivot in a first direction and said second segment extends from said pivot in a second direction opposite said first direction.

20. A support assembly for a vehicle closure member comprising:
an arm pivotally mountable about a pivot, said arm including a first segment extending in a first direction from said pivot and a second segment extending in a second direction from said pivot opposite said first direction; and
a spring assembly pivotally attached to said first segment for biasing said second segment against the vehicle closure member when the support assembly is attached to a vehicle closure member.

21. The assembly as recited in claim 20, wherein said first segment includes a length smaller than a length of said second segment.

22. The assembly as recited in claim 20, including an extension portion extending transversely from said second segment.
